(19) United States
(12) Patent Application Publication
(10) Pub. No.: US 2009/0164236 A1
(43) Pub. Date: Jun. 25, 2009

(54) SMARTER SCHEDULING FOR MEDICAL FACILITIES AND PHYSICIANS

(75) Inventors: Alexander Gounares, Kirkland, WA (US); Steven Bathiche, Kirkland, WA (US); Kim Cameron, Bellevue, WA (US); Oren Rosenbloom, Redmond, WA (US); Eric J. Horvitz, Kirkland, WA (US); Kenneth D. Ray, Seattle, WA (US); Hong L. Choing, Collegeville, PA (US); Hubert Van Hoof, Seattle, WA (US); Chris Demetrios Karkanias, Sammamish, WA (US)

Correspondence Address: TUROCY & WATSON, LLP, 127 Public Square, 57th Floor, Key Tower, CLEVELAND, OH, 44114, US

(73) Assignee: Microsoft Corporation, Redmond, WA (US)

(21) Appl. No.: 11/962,473

(22) Filed: Dec. 21, 2007

(51) Int. Cl. G06Q 50/00

(52) U.S. Cl. 705/2

(57) ABSTRACT

The claimed subject matter provides a system and/or a method that facilitates scheduling an incoming patient appointment for a medical facility. A medical facility can provide healthcare to a patient, wherein the medical facility can utilize a schedule with an available time slot to assign an appointment to a patient. A match component can evaluate a portion of transportation data to select a patient to which an appointment on the schedule is allotted. A dynamic schedule component can automatically adjust the schedule based upon the evaluation.

### BACKGROUND

Technological advances in computer hardware, software and networking have lead to increased demand for electronic information exchange rather than through conventional techniques such as paper correspondence, for example. Such electronic communication can provide split-second, reliable data transfer between essentially any two locations throughout the world. Many industries and consumers are leveraging such technology to improve efficiency and decrease cost through web-based (e.g., on-line) services. For example, consumers can purchase goods, review bank statements, research products and companies, obtain real-time stock quotes, download brochures, etc. with the click of a mouse and at the convenience of home.

In light of such technological advances, people in general tend to be more and more concerned about using their time in a more efficient manner. For example, cell phones, handhelds, wireless Internet, portable digital assistants (PDAs), and the like have enabled people to increase productivity and decrease downtime. In addition, the non-stop, fast-paced mentality of today's society demands responsiveness and if not provided, impatience and dissatisfaction sets in. Such responsiveness can be crucial to businesses, companies, enterprises, etc. in order to provide superior customer satisfaction since customer satisfaction plays a significant role in a fruitful business venture.

For example, within the medical profession and healthcare industry, superior skills must be coupled with courtesy in dealing with patients. In other words, a successful practice for doctors, nurses, specialists, etc. is a combination of medicinal knowledge and customer service. Thus, even though a patient may praise a medical professional for their expertise and comprehension of medicine, such patient-physician relationship will be typically short-lived if based solely on those characteristics and without tolerable customer/patient service. In general, providing patient care in prompt and efficient manner can be a very good barometer in determining the potential success or failure of a medical practice and/or medical facility.

A major concern associated with patient/customer care within the healthcare industry is optimizing a patient's time and a medical professional's time. Scheduling appointments for patients and managing patient traffic flow within a medical office/facility can be a daunting task. For instance, scheduling appointments for emergencies or sick patients who would like to be squeezed in can possibly overlap or bump existing appointments. In general, most medical professionals pride themselves on servicing every person that requires or request medical attention. Such characteristics are good for public welfare but can wreck havoc with scheduling appointments. Medical professionals would like to maximize the amount of patients that can be seen, while a patient would like to minimize the amount of downtime during an appointment (e.g., time in a waiting room, time waiting for a doctor, etc.). Medical professionals would ideally have their day to be as efficient as possible by scheduling a large number of people in a short period of time. In other words, the doctor cannot afford to wait on late patients and therefore schedules appropriately such that if a small percentage of patients are late, patients can be seen in an efficient manner. From a patient perspective, a trip to a medical related appointment can often translate into more time waiting than one would like. In addition, a schedule for a patient can change. Medical facilities typically recommend a time period prior to cancellation which further complicates medical appointment scheduling.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate employing a dynamic adjustment to a schedule associated with a medical facility. A dynamic schedule component can provide a real time adjustment to a schedule associated with a medical facility, wherein the schedule can be related to an emergency medical care situation or a scheduled appointment for a medical professional or medical facility. A match component can optimally select a patient to allot an appointment on the schedule based on evaluating a portion of transportation data and/or updates related to a schedule (e.g., cancellations, facility on schedule, facility behind schedule, medical professional on schedule, medical professional behind schedule, real-time updates from the medical professional, real-time updates from the medical facility, etc.). The match component can examine transportation data such as a patient location, a determination or prediction on whether a patient can make an appointment in time, a GPS determined location, and/or a portion of calendar data. Based on analyzing the transportation data for a patient, the match component can identify a patient to assign to an appointment.

In one example, a calendar can be shared with a medical facility and/or medical professional in a secure, anonymous manner, to enable the match component to efficiently select a patient that can attend an appointment. In addition, the calendar can include a ranking from a patient for each event to inform of a degree or amount of flexibility of such event. Thus, if an event is flexible based on the event ranking, the patient may be able to cancel such calendar event (e.g., a hair cut, dinner, grocery shopping, etc.) to make a medical appointment. In addition, the ranking can allow at least one of a patient or a medical professional to classify the severity of appointment. For instance, the appointment can be displayed via color coding on a shared calendar accessible by both parties. The color coding can allow medical professionals to reschedule and prioritize appointments if an unforeseen event happens. For example, an emergency or time sensitive appointment can take priority over a routine check-up appointment (e.g., color coded with yellow). In another example, a patient's personal health record (PHR) can be accessed to make a determination of priority. Moreover, a shared calendar can enable a patient to access his or her specific appointments. The patient may also opt-in to receive alerts and/or reminders of appointments which can be delivered via a portal sponsored by the medical professionals to email, text messages, etc.

In accordance with another aspect of the claimed subject matter, the dynamic schedule component can employ a compensation component that can provide a benefit to a patient to give incentive to accept an appointment, switch an appointment, change an appointment, or cancel an appointment to maximize scheduling. In other aspects of the claimed subject matter, methods are provided that facilitate a dynamic adjustment to a schedule associated with a medical facility.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates employing a dynamic adjustment to a schedule associated with a medical facility.

FIG. 2 illustrates a block diagram of an exemplary system that facilitates managing a plurality of schedules related to one or more medical facilities in an efficient and optimal manner.

FIG. 3 illustrates a block diagram of an exemplary system that facilitates communicating an adjustment to a medical facility schedule to one or more patients.

FIG. 4 illustrates a block diagram of an exemplary system that facilitates identifying a patient to schedule for an appointment with at least one of a medical professional or a medical facility.

FIG. 5 illustrates a block diagram of exemplary system that facilitates selecting a patient to fill an appointment slot on a schedule for the medical facility.

FIG. 6 illustrates a block diagram of an exemplary system that facilitates selecting at least one of a medical facility to transport a patient in need of emergency care or a patient to assign an appointment on a schedule.

FIG. 7 illustrates an exemplary methodology for managing a plurality of schedules related to one or more medical facilities in an efficient and optimal manner.

FIG. 8 illustrates an exemplary methodology that facilitates identifying a patient to schedule for an appointment with at least one of a medical professional or a medical facility.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “schedule,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

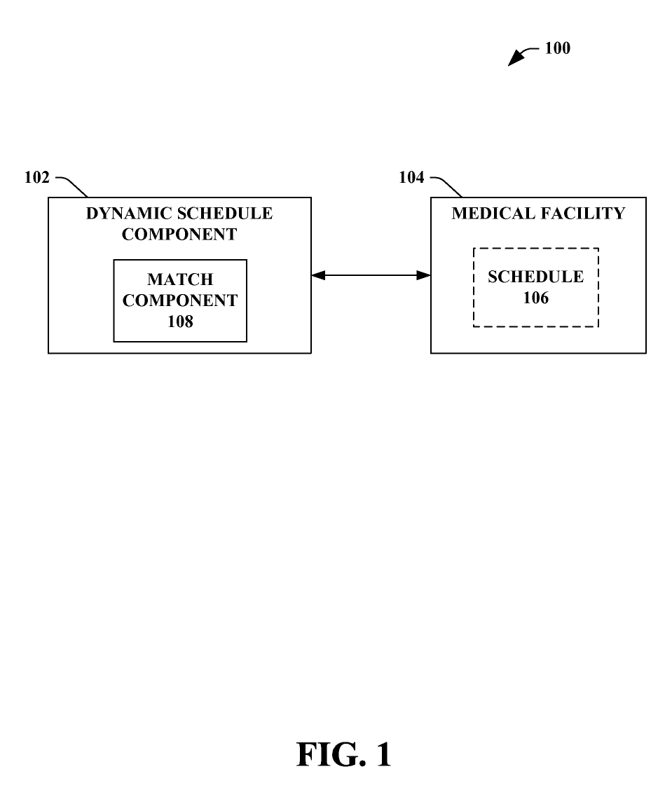

Now turning to the figures, FIG. 1 illustrates a system 100 that facilitates employing a dynamic adjustment to a schedule associated with a medical facility. The system 100 can include a dynamic schedule component 102 that can automatically employ an adjustment to a schedule 106 associated with a medical facility 104 in real time. The medical facility 104 can utilize the schedule 106 to assign time slots for an appointment between a patient and an entity related to such medical facility. In general, the dynamic schedule component 102 can manage assignment, re-assignment, an available time slot, a patient, a medical professional, etc. associated with the schedule 106. Moreover, the dynamic schedule component 102 can manage the schedule 106 with adjustments and communicate such adjustments to any suitable entity (e.g., patient, medical professional, contact for the patient, entity related to the medical facility 104, etc.).

For example, a medical facility such as a physical therapist can include a schedule with a list of patients and appointments at time slots for each work day. Typically, patients and/or medical professionals can run late, wherein the dynamic schedule component 102 can automatically adjust appointments and respective time slots in light of such tardiness. Moreover, the dynamic schedule component 102 can inform at least one of a patient or a medical professional of such adjustment. By dynamically adjusting the schedule of appointments and respective time slots, the time for patient and medical professional can be utilized in an optimal manner.

In another example, the dynamic schedule component 102 can manage the schedule 106 in a patient-specific manner upon the initiation of an appointment within the schedule 106 for the medical facility 104. Thus, upon a patient scheduling of an appointment for the medical facility 104, the dynamic schedule component 102 can aggregate data specific to such patient in order to tailor the allotted time slot within the schedule 106 accordingly. For example, a patient can typically be on-time and prompt with appointments for the medical facility 104, wherein such appointment scheduled can be assigned for a prompt start time and a short appointment. In another example, the dynamic schedule component 102 can adjust the schedule 106 based upon a cancellation of an appointment for the medical facility 104. In such example, the dynamic schedule component 102 can automatically re-assign the appointment to another patient in order to maximize use of the schedule 106 and/or the available time slots.

The system 100 can further utilize a match component 108 that can evaluate a portion of transportation data, wherein such portion of data can be utilized to identify an optimal patient for an appointment. It is to be appreciated that the match component 108 can appropriately identify at least one of the patient or the medical care. The match component 108 can evaluate a portion of transportation data such as, but not limited to, traffic patterns, previous traffic flows, location of patient, history of traffic patterns, directions, distance, and/or any other suitable data associated with a patient arriving to a medical facility for a scheduled appointment.

In addition, the system 100 can include any suitable and/or necessary interface component (not shown), which provides various adapters, connectors, channels, communication paths, etc. to integrate the dynamic schedule component 102 into virtually any operating and/or database system(s) and/or with one another. In addition, the interface component can provide various adapters, connectors, channels, communication paths, etc., that provide for interaction with the dynamic schedule component 102, the medical facility 104, the schedule 106, and any other device and/or component associated with the system 100.

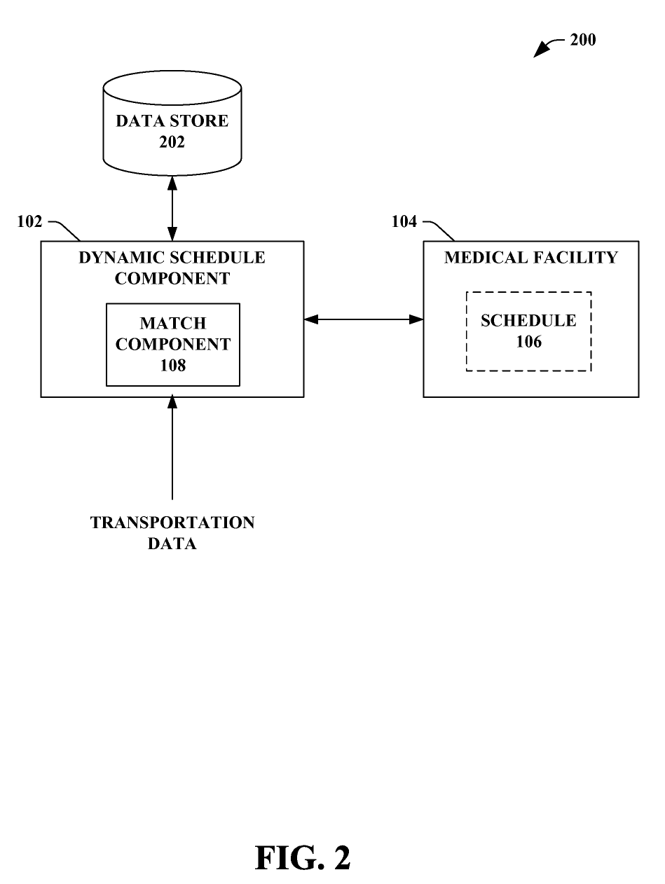

FIG. 2 illustrates a system 200 that facilitates managing a plurality of schedules related to one or more medical facilities in an efficient and optimal manner. The system 200 can include the dynamic schedule component 102 that can automatically adjust the schedule 106 associated with the medical facility 104 in order to optimize appointments between a medical professional and a patient. For instance, the dynamic schedule component 102 can utilize the match component 108 to identify a patient to which an appointment should be allotted based on transportation data that includes traffic predictions, traffic flow, etc. The dynamic schedule component 102 can leverage an opportunistic model for scheduling and optimizing workflow in connection with the medical facility 104. In general, the dynamic schedule component 102 can automatically and dynamically adjust the schedule 106 based at least in part upon a patient cancellation, an available time slot, a medical professional, a patient tendency, a medical tendency, a patient physical location, transportation data (e.g., traffic flow, traffic prediction, patient location, medical facility location, GPS, calendar data, etc.), updates related to a schedule (e.g., cancellations, facility on schedule, facility behind schedule, medical professional on schedule, medical professional behind schedule, real-time updates from the medical professional, real-time updates from the medical facility, etc.), and/or any other suitable data that can affect an appointment between a patient and a medical professional. Moreover, such schedule 106 can be related to any suitable appointment (e.g., emergency, routine check up, etc.) and can be associated with any suitable medical professional, medical facility, etc. It is to be appreciated that the subject innovation can be utilized with any suitable number of schedules, patients, medical professionals, medical facilities, and the like.

The match component 108 can evaluate and/or examine a portion of transportation data to select a patient in which to assign an available appointment for the medical facility and/or a medical professional. Once a match is made, the dynamic schedule component 102 can adjust the schedule 106 accordingly (e.g., annotate the schedule 106 to communicate an emergency care situation, an appointment being allotted to a patient, etc.). For instance, the match component 108 can evaluate transportation data such as, patient status, health condition, urgency of need for care, availability, indication of availability, costs, traffic patterns, history traffic data, emergency vehicle traffic flow, real time flow of traffic, road construction, detours, directions, traffic from an event (e.g., concert, sporting events, parades, celebrations, holidays, etc.), a global positioning system (GPS) location, a shared and/or online calendar for a patient, available assets, resources, a predicted outcome or time involved (e.g., seasonal allergies in which a patient frequently sees a doctor for a prescription can be predicted to be a short visit), market pressures, a monetary value determination (e.g., ascertain value to patient, ascertain value to doctor, etc.), patients pre-assigned or preferred physicians, etc. It is to be appreciated that the match component 108 can select and/or match an appointment on the schedule 106 to a patient based on examining the transportation data in a dynamic and seamless manner so as to enable optimal patient care.

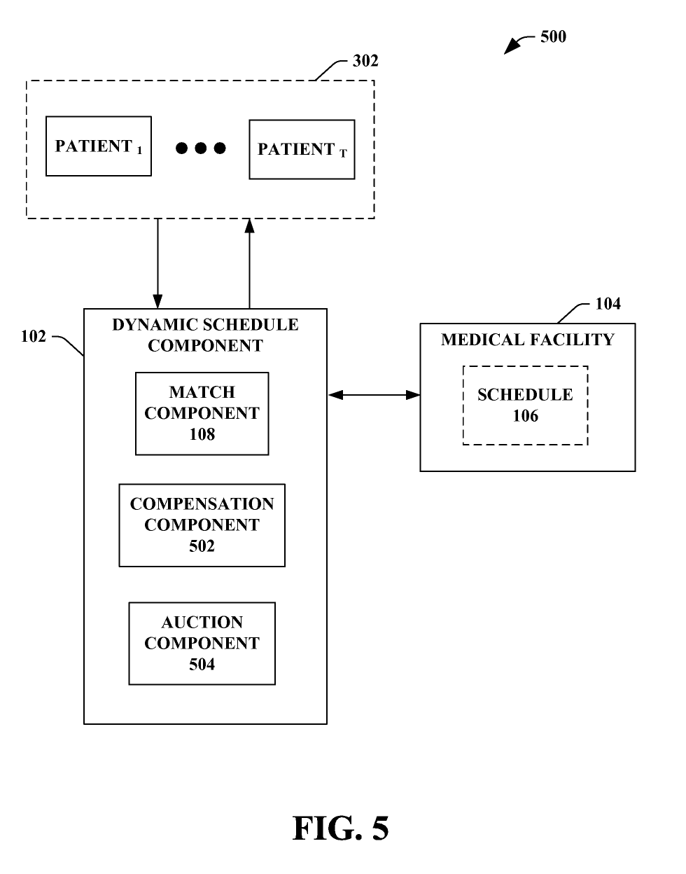

In another example, the match component 108 can select a patient for an appointment with a medical professional and/or a medical facility. The dynamic schedule component 102 can detect a change in the schedule 106 such as a cancellation of an appointment, an open appointment, a new appointment, etc., wherein such detection can employ the match component 108 to identify a suitable replacement for the appointment. The match component 108 can evaluate any suitable data related to a patient and/or transportation data in order to identify an optimal patient to fill the appointment. The transportation data can be evaluated to match a patient with an appointment based on traffic, traffic patterns, traffic flow, whether the patient can make the appointment in time, calendar openings, location, distance, health conditions, patient urgency, severity of condition, treatment, timeliness, frequency of visits, etc. In another example, the match component 108 can identify a patient that is willing to trade, donate, or opt out of an appointment in order to allow efficient scheduling for patients (e.g., see FIG. 5 for more details in connection with compensation).

The system 200 can further include a data store 202 that can include any suitable data related to the dynamic schedule component 102, the medical facility 104, the schedule 106, the match component 108, etc. For example, the data store 202 can include, but not limited to including, a portion of transportation data, a portion of data related to a patient, a portion of data related to the schedule 106, a portion of data associated with the medical facility 104, a portion of data related to a medical professional 204, traffic data, traffic history, traffic flow, routes, directions, traffic tendencies, traffic patterns, traffic data, available appointments, time slots, cancellations, patient tendencies, medical professional tendencies, etc.

It is to be appreciated that the data store 202 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 202 of the subject systems and methods is intended to comprise, without being limited to, these and any other suitable types of memory. In addition, it is to be appreciated that the data store 202 can be a server, a database, a hard drive, a pen drive, an external hard drive, a portable hard drive, and the like.

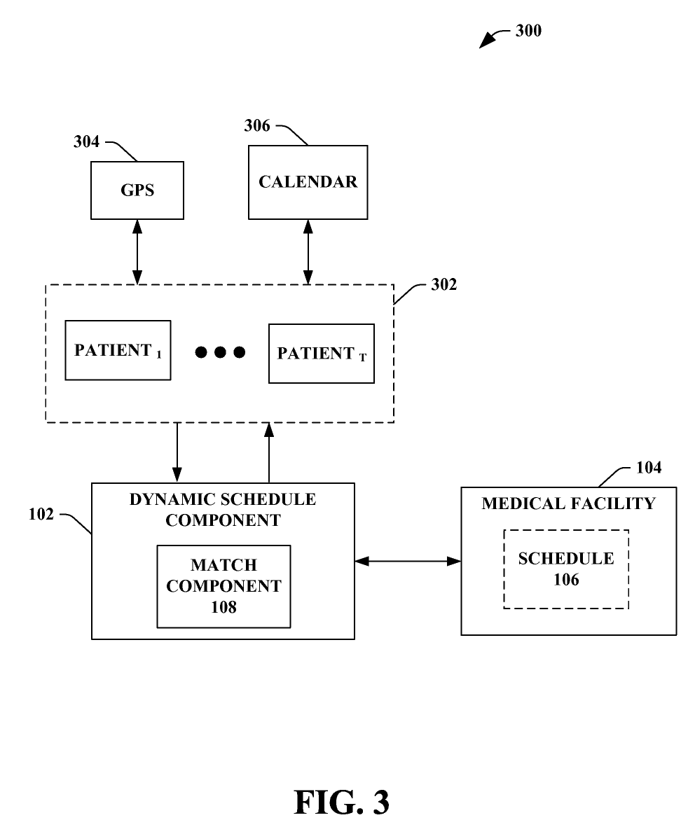

FIG. 3 illustrates a system 300 that facilitates communicating an adjustment to a medical facility schedule to one or more patients. The system 300 can include the dynamic schedule component 102 that can automatically adjust the schedule 106 with appointments for the medical facility 104. It is to be appreciated that the dynamic schedule component 102 can interact with a plurality of patients 302 that can maintain an appointment in connection with the schedule 106. For instance, the dynamic schedule component 102 can interact with any suitable number of patients 302 such as patient ₁ to patient _{T}, where T is a positive integer. In general, the patients 302 can be shuffled and/or assigned into available appointments for the medical facility 104 based at least in part upon a cancellation, an appointment opening, a medical professional availability, a patient availability, a timeliness of an appointment (e.g., patient being tardy, a medical physician being tardy, etc.), and/or any other situations in which an appointment may need adjusting in order to maximize time efficiency for at least one of the medical professional and the patient. Moreover, the match component 108 can identify a patient for an appointment based on examining and/or evaluating transportation data.

The match component 108 can utilize location-type transportation data in order to select a patient for an appointment. In particular, the system 300 can include a global positioning system (GPS) 304 that can provide a geographic location for a patient. This location can be utilized by the dynamic scheduling component 102 and/or the match component 108 in order to ascertain whether a patient is within a close proximity to allot an available appointment. It is to be appreciated that the GPS 304 can communicate such location data to the match component 108 and/or the dynamic schedule component 102 in a secure and private manner in which any identifying and/or private data can be anonymous but still keep patient-identifying characteristics. Furthermore, the GPS 304 can be incorporated into any suitable portable device such as, but not limited to, a mobile phone, a cellular device, a gaming device, a handheld, a laptop, a portable digital assistant (PDA), a portable media player, a wireless device, a data browsing device, etc. In general, any information and/or data collected or exposed from the patients 302 can be integrated with a secure manner so that information is kept private and confidential.

The dynamic schedule component 102 and/or the match component 108 can further utilize a calendar 306 associated with at least one patient. The match component 108 can match up appointments to patients based on situations, wherein the calendar 306 for a patient can be leveraged as an insightful tool to predict where a patient's location will be. For instance, a patient can opt to enable access to a calendar 306 (e.g., in a private manner) and the medical facility 104 and/or medical professional can implement a dynamic alert to notify the patient of an appointment that is available on the schedule 106. In another example, the calendar 306 can be shared with a patient that is local to the medical facility 104 using a calendar schema (e.g., harnessing opportunistic healthcare scheduling, etc.) and take in consideration of how long it will take such patient to arrive to the appointment. Yet, such calendar information, when shared, can be anonymously and/or privately utilized by the medical facility 104 and/or the medical professional. For example, a calendar sharing technique can be employed in which access can be based on a user's preference or setting for data on a calendar. Thus, a user can grant calendar access to a medical physician for a particular month but only to whether a time slot is open or taken (e.g., not displaying specific event details, etc.). In another example, the calendar data can be encrypted such that only authorized scheduling systems can view/utilize it.

In general, the calendar 306 can be leveraged by the match component 108 to assist in identifying an optimal patient to select, wherein characteristics of such patient and/or transportation data (e.g., traffic, traffic flow, mode of transportation, directions, location, needs, condition, status of patient, etc.) can be evaluated for such selection or scheduling. The calendar 306 can be leveraged in order to allow the match component 108 to select which patient can fill an available slot in the schedule 106, which patient will donate/switch an appointment in the schedule 106, etc. Moreover, the calendar 306 can be populated with additional metadata that describe which calendar items are moveable or changeable in the event an appointment is available, a degree of flexibility for a calendar item in the event an appointment is available, an amount of importance for a calendar item, an amount of money that could instigate a change in the calendar, a ranking of importance for a calendar item or event, etc. In addition, the ranking can allow at least one of a patient or a medical professional to classify the severity of appointment. For instance, the appointment can be displayed via color coding on a shared calendar accessible by both parties. The color coding can allow medical professionals to reschedule and prioritize appointments if an unforeseen event happens. For example, an emergency or time sensitive appointment can take priority over a routine check-up appointment (e.g., color coded with yellow). In another example, a patient's personal health record (PHR) can be accessed to make a determination of priority. Moreover, a shared calendar can enable a patient to access his or her specific appointments. The patient may also opt-in to receive alerts and/or reminders of appointments which can be delivered via a portal sponsored by the medical professionals to email, text messages, etc.

In another aspect in accordance with the subject innovation, the match component 108 can ascertain a “just in time” characteristic that can predict whether a matched patient can arrive in time for the appointment that is available. For instance, the match component 108 can utilize the determination of whether a patient can make an appointment on time or not as a factor to identify a match for an appointment. In other words, in addition to evaluating transportation data, the match component 108 can calculate which patients are more likely to arrive in time for an appointment and such calculation can be a determinative factor in selecting which patients are to be assigned to which appointment slots in the schedule 106. Thus, the dynamic schedule component 102 and/or the match component 108 can employ a closed loop adaptive system that takes into account a patient's behavior related to punctuality in order to allot a patient to an appointment. Moreover, the match component 108 can change his or her schedule and reply back in time to pick up a slot. By utilizing a query to determine whether or not a patient can fill such slot enables timely responses for enhanced operation. The rebalancing of the patient's schedule can be utilized in determination of another patient to fill a slot. In one particular example, the match component 108 can examine various transportation data in order to ascertain whether a patient can arrive for an appointment within a certain time frame. Thus, be evaluating location, weather, traffic, traffic flow, patient tendencies, routes, directions, mode of transportation, average speed, and/or other previously described transportation data that takes into account how long it will take a patient to arrive can allow a patient to be matched and/or identified as a candidate to have an available appointment slot assigned thereto.

In another example, the calendar 306 can be weighted accordingly based on the severity of an illness. Thus, items and/or events related to the calendar 306 can be decreased in importance based upon a severe illness that requires medical attention. Therefore, the medical facility 104 and/or the medical professional utilize the fact that certain events weighted accordingly can be moved, deleted, ignored, etc. in order to match the patient to an appointment. For instance, if you are sick, a patient/user may skip things to get to a medical professional and/or medical facility. Presence and availability can have location tabs in the calendar 306 as a weight for standard calendar schema with privacy controls and selecting sharing of such information. Multi-resolution, data sharing controls, etc. can tell a portion of individuals that you are in a meeting but are willing to skip such meeting to get an appointment with a medical professional and/or facility. In another aspect, the calendar 306 can include privacy and/or anonymous settings that allow approved entities to get particular amounts of data. Thus, a patient can reveal on his/her calendar that a meeting in the United States is set for a particular time. Yet, a medical professional and/or facility can have a higher setting for calendar data, wherein the calendar can indicate or reveal that such meeting is in Cleveland, Ohio within a close proximity of a hospital or medical professional that has an appointment (e.g., the calendar reveals more information to a medical professional and/or facility in comparison to individuals not related to healthcare). In general, it is to be appreciated that the calendar 306 can include various granular settings for privacy and/or data exposure in connection with items, events, move-ability, and/or flexibility associated therewith.

In one example, a Global Positioning System (GPS) enabled mobile device can locate a patient and selectively communicate desired information related to an adjustment to the schedule 106. For instance, a patient can receive an update that an available appointment has opened up due to a cancellation in which the patient can accept and/or deny, wherein such update was targeted to the patient based at least in part upon analysis from the match component 108. In general, if the medical facility 104 receives an appointment cancellation in connection with the schedule 106, the dynamic schedule component 102 and/or the match component 108 can locate a patient and selectively broadcast a message notifying nearby (e.g., within a proximity of the medical facility 104) of the opening. Thus, the system 300 can efficiently assign open slots for appointments to maximize scheduling. In another aspect, the dynamic schedule component 102 can provide a discounted service rate for patients who accept to fill a recently available appointment slot on the schedule 106. For instance, a discount can be provided to a patient for taking a time slot on the schedule 106 in a limited amount of time due to a recent cancellation.

Moreover, the system 300 can target specific patients and/or account for patient tendencies (e.g., individual needs, characteristics, etc.). In other words, the system 300 can adjust the schedule 106 based upon the patient tendencies (e.g., tardiness, average visit time, amount of questions asked, historic data related to the patient, geographic location, surrounding traffic, distance from patient home, etc.), the type of visit (e.g., routine check-up, specific diagnosis, type of disease, type of illness, type of pain, etc.), number of tests (e.g., x-rays, blood work, MRI, stress test, urine sample, etc.), medical professional tendencies (e.g., average appointment time, length of answers to questions, etc.), and/or any other suitable data related to the patient, the medical professional, the medical facility 104, and/or the schedule 106.

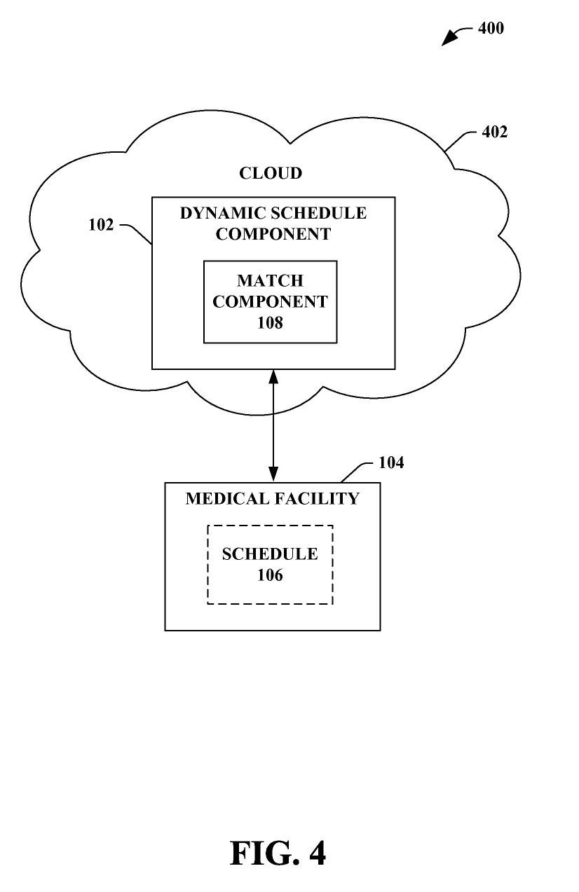

FIG. 4 illustrates a system 400 that can facilitate scheduling a patient for an appointment with at least one of a medical professional or a medical facility. The system 400 can utilize a cloud 402 that can incorporate at least one of the dynamic schedule component 102, the match component 108, and/or any suitable combination thereof. It is to be appreciated that the cloud 402 can include any suitable component, device, hardware, and/or software associated with the subject innovation. The cloud 402 can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). The cloud 402 is intended to include any service, network service, cloud service, collection of resources, etc. and can be accessed by an identified user via a network. For instance, two or more users can access, join, and/or interact with the cloud 402 and, in turn, at least one of the dynamic schedule component 102, the match component 108, and/or any suitable combination thereof. In addition, the cloud 402 can provide any suitable number of service(s) to any suitable number of user(s) and/or client(s). In particular, the cloud 402 can include resources and/or services that enable dynamically scheduling or updating a schedule related to a medical facility or a medical professional. In addition, the cloud 402 can provide interactive services that allow a user to access or share calendar data in order to optimize patient scheduling.

FIG. 5 illustrates a system 500 that facilities selecting a patient to fill an appointment slot on a schedule for the medical facility. The system 500 can include the dynamic schedule component 102 that automatically adjusts the schedule 106 for an appointment (e.g., emergency care, urgent care, schedule check-up, non-emergency care, etc.) with the medical facility 104 and/or a medical professional. In particular, the match component 108 can be utilized by the dynamic schedule component 102 in order to select a patient to allot a time slot for an appointment on the schedule 106. It is to be appreciated that the match component 108 can evaluate a portion of transportation data in order to identify an optimized selection a patient. In a specific example, the match component 108 can examine a patient's location, a calendar, a degree of flexibility in connection with the calendar, traffic, traffic flow, traffic prediction, whether a patient can make an appointment in time, a severity of a medical condition, a GPS location, and the like in order to select an optimal patient to schedule for an appointment.

The system 500 can include a compensation component 502 that can provide a benefit to a patient in the event of being selected to have an available appointment assigned thereto. The compensation component 502 can generate a benefit to a patient in the event that such patient accepts an appointment with or without limited notification. For example, if an appointment is cancelled by patient A, the system 500 can identify patient C as an optimal replacement, wherein the compensation component 502 can provide a benefit to patient C if the appointment is accepted. By providing incentive to accept the appointment with limited notice, a patient will be more likely to accept an appointment since there are benefits (e.g., getting an appointment to see the a medical professional, seeing the medical professional earlier, receiving a benefit for last minute schedule adjustments, etc.). It is to be appreciated that the benefit can be any suitable compensation to a patient to reward acceptance of an appointment time slot, such as, but not limited to, a monetary benefit, a coupon, a discount for a service, a good (e.g., a poster, a shirt, a hat, a media player, a portion of software, a portion of an application, computer hardware, candy, food, drink, etc.), a service, a quality of care for the patient, a convenience to the patient, etc. In general, the compensation component 502 can match a benefit that correlates with the situation surrounding an acceptance of an appointment. Thus, a last-minute acceptance can yield a higher benefit in comparison to an acceptance of an appointment with a days notice.

Moreover, the compensation component 502 can provide a benefit to a patient who opts to donate and/or switch an appointment with another in order to maximize use of time in relation to the schedule 106. In other words, a benefit can be given to a patient who, upon determination of the match component 108 and/or the dynamic schedule component 102, is selected for an appointment utilizing a swapping or donating of an appointment on the schedule 106. For instance, the match component 108 and/or the dynamic schedule component 102 can identify a need for a patient appointment to be changed, wherein certain patients with appointments can be identified for possible swapping and/or donation of appointments. In order to entice such patients to swap and/or donate, the compensation component 502 can provide a benefit to such generous individuals. In particular, a medical professional may require appointments to be cleared or moved in light of a family emergency, a vacation, personal time, medical condition, etc. Such re-shuffling and/or schedule adjustments can be employed while compensating individuals so as to enable fair schedule management.

The system 500 can further include an auction component 504 that can allow for a medical professional and/or the medical facility to bid for the right to treat a patient. The auction component 504 can enable negotiations between medical facilities, medical professionals, and/or any suitable combination thereof for rights to treat a new patient, a group of patients, etc. For example, one or more patients can be opt into an auctioning service for a fixed rate, wherein a set amount of medical care can be provided by a medical facility and/or a medical professional. Based on opting into such service, one or more medical professionals and/or medical facilities can bid on the right to provide medical care for a particular patient or a group of patients. It is to be appreciated that the bidding can be based on any suitable characteristic such as, but not limited to, area of expertise, desire to get experience, experimental purposes, knowledge of conditions, etc. In another example, the patient that has opted into such service can include a condition that allows the patient to approve or disapprove the winning bidder so as to ensure a healthy relationship. Moreover, it is to be appreciated that the patient can pre-approve or disapprove a group of medical professionals and/or medical facilities. In one example, the auctioning can be applied to the start of a medical relationship. In another example, the auctioning can be in light of a patient opting into such service due to a change in patient-doctor relationship (e.g., re-location of patient, change in medical offices, discovery of another doctor, decrease in Insurance coverage, etc.).

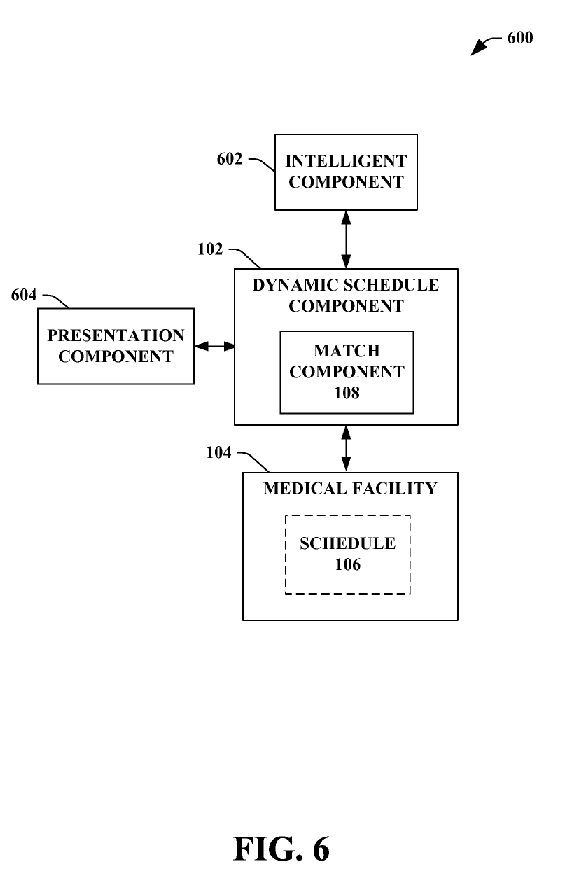

FIG. 6 illustrates a system 600 that employs intelligence to facilitate selecting at least one of a medical facility to transport a patient in need of emergency care or a patient to assign an appointment on a schedule. The system 600 can include the dynamic schedule component 102, the medical facility 104, the schedule 106, and/or the match component 108. It is to be appreciated that the dynamic schedule component 102, the medical facility 104, the schedule 106, and/or the match component 108 can be substantially similar to respective components, facilities, and schedules, described in previous figures. The system 600 further includes an intelligent component 602. The intelligent component 602 can be utilized by at least one of the dynamic schedule component 102 and/or the match component 108 to facilitate optimally identifying at least one of a patient to allot an appointment or a medical facility to transport a patient. For example, the intelligent component 602 can utilize inference techniques in connection with transportation data, selecting a patient to allot an appointment on a schedule, traffic data, traffic prediction, directions, whether a patient can make an appointment in time, etc.

The intelligent component 602 can employ value of information (VOI) computation in order to identify a patient to assign an appointment. For instance, by utilizing VOI computation, the most ideal and/or appropriate patient can be determined. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The system 600 can further utilize a presentation component 604 that provides various types of user interfaces to facilitate interaction between a user and any component associated with the system 600. As depicted, the presentation component 604 is a separate entity that can be utilized with the dynamic schedule component 102. However, it is to be appreciated that the presentation component 604 and/or similar view components can be incorporated into the dynamic schedule component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the dynamic schedule component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

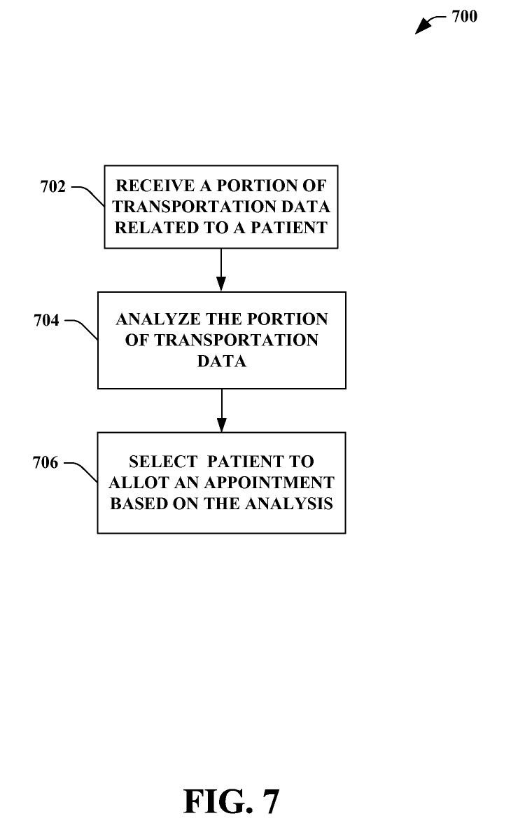

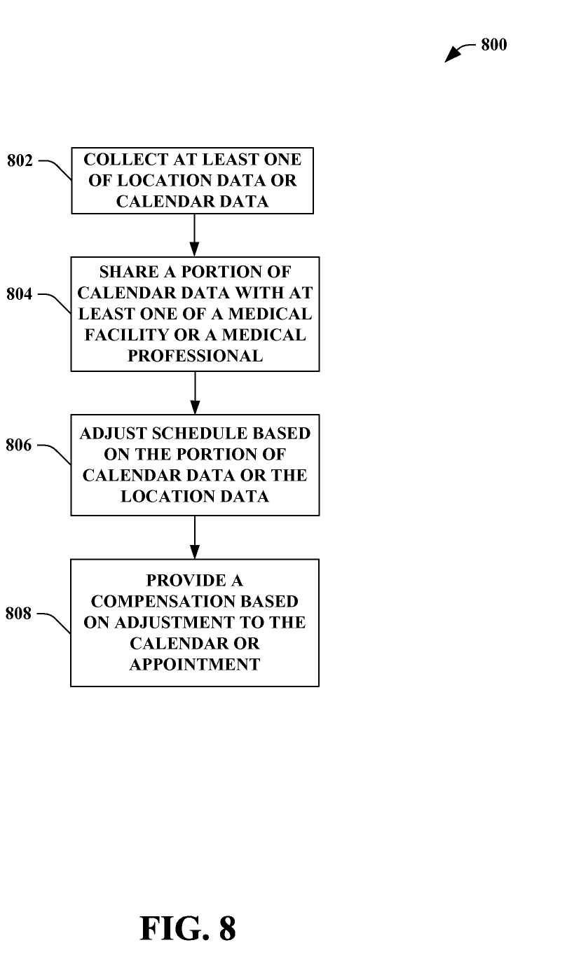

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates managing a plurality of schedules related to one or more medical facilities in an efficient and optimal manner. At reference numeral 702, a portion of transportation data can be received. The portion of transportation data can be, but is not limited to being, traffic patterns, previous traffic flows, location of patient, history of traffic patterns, directions, distance, health condition, urgency of need for care, availability, indication of availability, costs, real time flow of traffic, road construction, detours, traffic from an event (e.g., concert, sporting events, parades, celebrations, holidays, etc.), a global positioning system (GPS) location, a shared and/or online calendar for a patient, available assets, resources, a predicted outcome or time involved (e.g., seasonal allergies in which a patient frequently sees a doctor for a prescription can be predicted to be a short visit), market pressures, a monetary value determination (e.g., ascertain value to patient, ascertain value to doctor, etc.), patients pre-assigned or preferred physicians, and/or any other suitable data associated with an appointment or a potential patient to fill such appointment.

At reference numeral 704, the portion of transportation data can be analyzed. It is to be appreciated that the portion of transportation data can be analyzed dynamically, as a contingency plan, and/or any suitable combination thereof. At reference numeral 706, a patient to allot an appointment can be selected based on the analysis. In other words, the transportation data can be evaluated and/or examined in order to identify an optimal match for a patient and an available appointment. In other words, a patient can be optimally selected to fill an appointment scheduled with a medical facility or a medical professional based on the evaluation of the portion of transportation data.

FIG. 8 illustrates a method 800 for dynamically selecting a patient to allot a time slot for an appointment in an optimal and efficient manner. At reference numeral 802, at least one of location data or a portion of calendar data can be received, wherein such calendar data can be associated with a potential patient or an existing patient. The location data can relate to GPS data associated with a user or any other information that indicates a geographic location for a user. It is to be appreciated the calendar data can include information, metadata, etc. related to a user and appointments, scheduled appointments, meetings, events, and the like. At reference numeral 804, a portion of calendar data can be shared with at least one of a medical facility or a medical professional. It is to be appreciated that the portion of calendar data can be private and confidentially shared. For instance, the portion of calendar data can be anonymous but still keep patient-identifying characteristics. In another example, a calendar sharing technique can be employed in which access can be based on a user's preference or setting for data on a calendar. Thus, a user can grant calendar access to a medical physician for a particular month but only to whether a time slot is open or taken (e.g., not displaying specific event details, etc.). In another example, the calendar data can be encrypted such that only authorized scheduling systems can view/utilize it.

At reference numeral 806, the schedule can be dynamically adjusted based at least in part upon the calendar data or the location data. In particular, at least one of a calendar or the portion of location data can be examined in order to select a patient for a schedule manipulation. It is to be appreciated that the schedule manipulation can be at least one of swapping appointments, donating an appointment, canceling an appointment, scheduling an appointment, and/or any other suitable change in a schedule related to a medical facility and/or a medical professional.

At reference numeral 808, a benefit or compensation can be provided based on adjustment to the calendar or appointment. Particularly, the selected patient can be selected based at least in part upon an acceptance of the schedule manipulation, wherein the benefit can be any suitable compensation to a patient to reward acceptance of a schedule change (e.g., a schedule manipulation), such as, but not limited to, a monetary benefit, a coupon, a discount for a service, a good (e.g., a poster, a shirt, a hat, a media player, a portion of software, a portion of an application, computer hardware, candy, food, drink, etc.), a service, etc. In general, a benefit can be matched based on a correlation with the situation surrounding an acceptance of an appointment change.

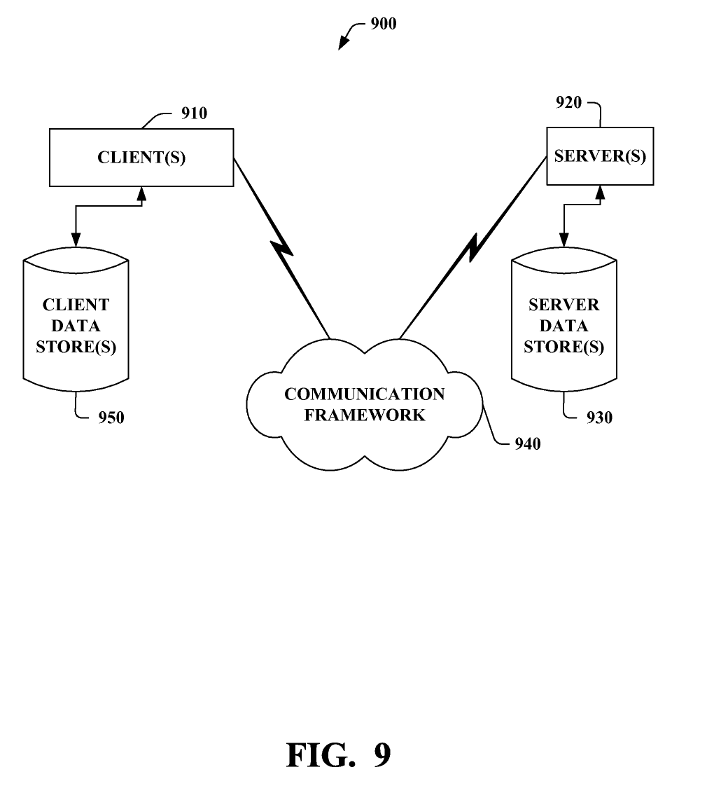

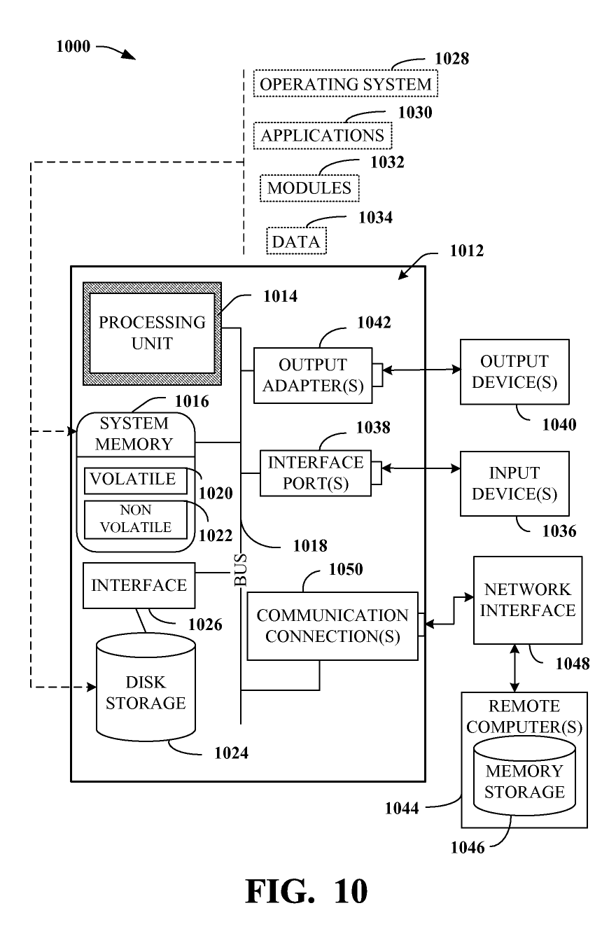

In order to provide additional context for implementing various aspects of the claimed subject matter, FIGS. 9-10 and the following discussion is intended to provide a brief, general description of a suitable computing environment in which the various aspects of the subject innovation may be implemented. For example, a dynamic schedule component that can automatically adjust a schedule to increase use of appointment time slots, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A computer-implemented system that facilitates scheduling an incoming patient appointment for a medical facility, comprising:
a medical facility that provides healthcare to a patient, the medical facility utilizes a schedule with an available time slot to assign an appointment to a patient;
a match component that evaluates a portion of transportation data to select a patient to allot an appointment on the schedule; and
a dynamic schedule component that automatically adjusts the schedule based upon the evaluation.

2. The system of claim 1, the match component evaluates the portion of transportation data to identify the patient, the evaluation enables the determination of at least one of a traffic pattern, a traffic flow, a prediction of traffic, a traffic evaluation, a portion of historic data related to traffic, a set of directions, a route, a medical asset, a medical need for the patient, or a patient status.

3. The system of claim 1, the portion of transportation data relates to at least one of a location of patient, a distance to a medical facility, a health condition, an urgency of need for care, a cost, a real time flow of traffic, a portion of road construction, a detour, a portion of traffic from an event, a predicted outcome, an amount of time involved, a patient pre-assigned physician, a preferred physician, a monetary value determination, or a market pressure.

4. The system of claim 1, the match component evaluates the portion of transportation data in which the transportation data relates to at least one of a global positioning system (GPS) determined location, a calculation whether a patient will arrive in time for the appointment, or a calendar associated with a patient.

5. The system of claim 4, the calendar includes at least one event with a ranking defined by the patient to signify an amount of flexibility to change the event upon selection for an appointment.

6. The system of claim 4, the GPS is incorporated into a portable device, the portable device is at least one of a mobile phone, a cellular device, a gaming device, a handheld, a laptop, a portable digital assistant (PDA), a portable media player, a wireless device, or a data browsing device.

7. The system of claim 4, the dynamic schedule component enables the patient to opt-in to receive an alert of an appointment which can be delivered via a portal sponsored by at least one of the medical facility or the medical professional.

8. The system of claim 4, an event on the calendar is color coded in accordance with the ranking defined by the patient in order to depict flexibility.

9. The system of claim 1, the portion of transportation data is secured anonymously in a private manner to protect an identity of the patient.

10. The system of claim 1, further comprising a compensation component that provides a benefit to a selected patient, the benefit is at least one of a monetary benefit, a coupon, a discount for a service, a good, or a service.

11. The system of claim 10, the compensation component provides the benefit to the selected patient upon acceptance of a manipulation to the schedule, the manipulation is at least one of a change of an appointment, a cancellation of an appointment, a swapping of an appointment, or an acceptance of an appointment.

12. The system of claim 11, the compensation component correlates the benefit with a timeliness of notification to the selected patient.

13. The system of claim 1, the dynamic schedule component employs a closed loop adaptive system that takes into account a patient's behavior related to punctuality in order to allot a patient to an appointment.

14. The system of claim 1, further comprising an auction component that allows at least one of the medical facility or a medical professional to bid on a right to care for at least one patient, wherein a high bidder secures the right to provide healthcare to the patient.

15. The system of claim 1, further comprising a cloud that incorporates at least one of the dynamic schedule component or the match component.

16. The system of claim 15, the cloud is a collection of resources maintained by a party and accessible by an identified user over a network.

17. A computer-implemented method that facilitates optimizing a traffic flow with a medical facility, comprising:
receiving a portion of transportation data related to a patient;
analyzing the portion of transportation data; and
selecting a patient to allot an appointment based on the analysis.

18. The method of claim 17, further comprising:
providing a benefit to a selected patient based on a timeliness of appointment notification;
sharing a portion of calendar data associated with the patient to at least one of the medical facility or the medical professional; and
ranking an event related to the calendar based on a user-defined flexibility of adjusting such event.

19. The method of claim 17, the portion of transportation data relates to a traffic pattern, a traffic prediction, a location of a medical facility, a location of a patient, a set of directions to a medical facility, a determination of whether a patient can arrive in time for the appointment, an availability of a medical professional, a health status for a patient, or a calendar related to a patient.

20. A computer-implemented system that facilitates scheduling an incoming patient appointment for a medical facility, comprising:
means for utilizing a schedule within a medical facility to provide healthcare to a patient, the schedule includes an available time slot to assign an appointment to a patient;
means for evaluating a portion of transportation data to select a patient to allot an appointment on the schedule; and
means for automatically adjusts the schedule based upon the evaluation.
